(19) United States
(12) Patent Application Publication
(10) Pub. No.: US 2007/0098524 A1
(43) Pub. Date: May 3, 2007

(54) Conical nut

(76) Inventors: William L. Dunlap, Elkhart, IN (US); Daniel W. Bard, Middlebury, IN (US)

Correspondence Address: Jeffrey Thurnau;The Gates Corporation, Mail Stop: IP Law Dept. 10-A3, 1551 Wewatta Street, Denver, CO, 80202, US

(21) Appl. No.: 11/263,004

(22) Filed: Oct. 31, 2005

(51) Int. Cl. F16B 43/00

(52) U.S. Cl. 411/533

(57) ABSTRACT

A conical nut comprising a body having a cylindrical portion, a first threaded bore and a flange extending substantially normal to the cylindrical portion, a biasing member comprising at least two disc springs, each disc spring having a bore engagable with the cylindrical portion, a seat having a tapered surface and having a second bore engagable with the cylindrical portion, the biasing member disposed between the flange and the seat, and a containing member engaged to the flange and the seat whereby the biasing member is contained between the flange and the seat.

### FIELD OF THE INVENTION

The invention relates to a conical nut, and more particularly, to a conical wheel nut having a disc spring and a jacket.

### BACKGROUND OF INVENTION

A common problem encountered by freight haul tractor trailers, as well as smaller trailers used for non-commercial purposes such as recreational trailers, is the loosening of the lug nuts on the wheels of the trailer.

A common problem results from methods used to secure nuts to lug bolts on new truck and trailer wheels. For example, a new wheel will usually have several coats of paint. The nuts are tightened down on the wheel to a predetermined torque value, for example, 120 foot-pounds, which compresses the paint on the wheel. The compressed paint layers on the wheel do not possess sufficient mechanical strength to sustain a proper preload in the wheel studs and thereby, a proper torque on the nuts. Also, small positional errors of the stud relative to the wheels' nut seats can result in excessive localized contact pressure between the nuts and nut seats. Under the normal loading of the wheels, the paint will be extruded from the nut seat and the metallic material of the nuts and nut seats will yield plastically. This “seating-in” process results in a reduction of the clamp force, and thereby the torque, which holds the wheel to the axle hub. This can over time create a gap between the nut and the wheel which enables the initially tight nuts to loosen up.

Further, the stacking of components on a vehicle wheel hub, in addition to the paint, creates a cumulative thickness of the stacked parts. The initial torque can force the material of the stacked components to yield, thereby allowing the nuts to loosen by “bleeding off” the initial torque and preload, again, causing the nut to loosen.

Loss of torque can also occur as a result of long storage periods where the wheel assembly is subjected to repeated cycles of heating and cooling.

Once the nuts have loosened, the wheel is able to rock and wobble back and forth on the lug bolts. After a period of time, the lug hole diameter in the wheel can be significantly enlarged, damaging the wheel as well as severely degrading the stability of the trailer, rending it uncontrollable. Also, relative movement of the wheel can result in fatigue failure of the lug bolts, causing catastrophic separation of the wheel from the axle hub. For example, in an emergency or panic stop, hard application of the brakes can shear off the lug bolts, thus rendering the trailer or vehicle uncontrollable. The wheel can become a dangerous projectile as well, capable of seriously injuring others.

This situation can be further aggravated by the accumulation of debris on the various engaged, load bearing surfaces of the lug nut system.

Representative of the art is U.S. Pat. No. 5,827,025 (1998) to Henriksen which discloses a self-tensioning, disc spring assembly. The assembly has a circular disc spring with an outer diameter and an inner diameter defining a center hole. The disc spring has a height greater at the inner diameter than at the outer diameter. The disc spring is also resiliently compressible such that it can be flattened. A zinc element, being zinc or a zinc alloy, is provided in the form of a ring or other shape, or a surface deposit on the disc spring or nut, to prevent rusting of the lug bolt.

What is needed is a conical wheel nut having a disc spring and a jacket. The present invention meets this need.

### SUMMARY OF THE INVENTION

The primary aspect of the invention is to provide a conical wheel nut having a disc spring and a jacket.

Other aspects of the invention will be pointed out or made obvious by the following description of the invention and the accompanying drawings.

The invention comprises a conical nut comprising a body having a cylindrical portion, a first threaded bore and a flange extending substantially normal to the cylindrical portion, a biasing member comprising at least two disc springs, each disc spring having a bore engagable with the cylindrical portion, a seat having a tapered surface and having a second bore engagable with the cylindrical portion, the biasing member disposed between the flange and the seat, and a containing member engaged to the flange and the seat whereby the biasing member is contained between the flange and the seat.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross-sectional view of the conical nut.

FIG. 2 is a cross-sectional view of the disc spring.

FIG. 3 is a cross-sectional view of the conical seat.

FIG. 4 is a plan view of the jacket.

FIG. 5 is section 5-5 in FIG. 4.

FIG. 6 is a cross-sectional view of the conical nut installed on a wheel hub.

### DETAILED DESCRIPTION OF THE PREFERRED EMBODIMENT

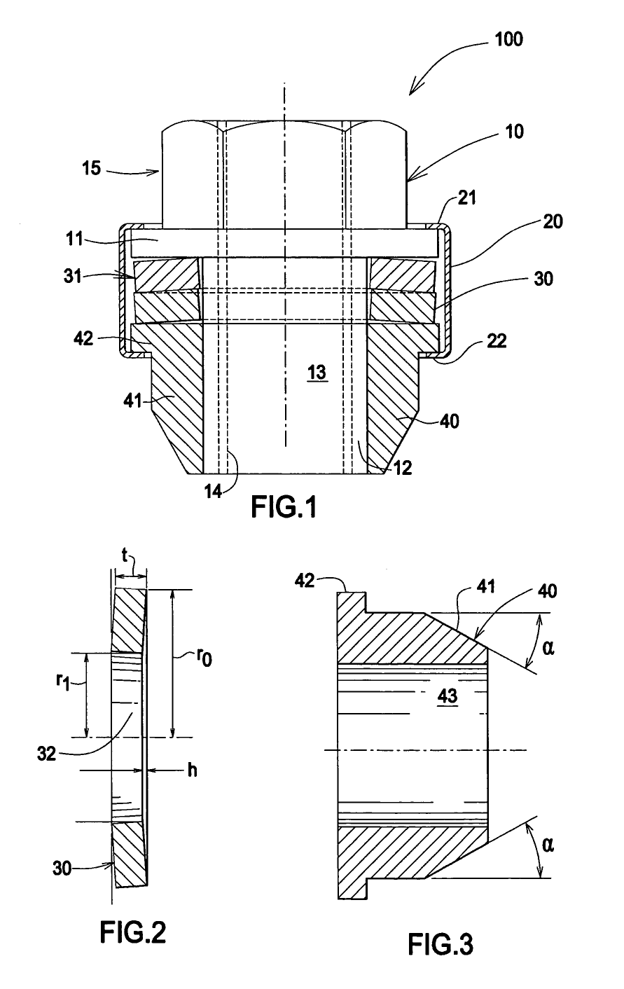

FIG. 1 is a cross-sectional view of the conical nut. Conical nut 100 comprises nut 10 and disc springs 30, 31. Disc springs 30, 31 and conical seat 40 are engaged about a shank 12. Nut 10 and shank 12 comprise the body. Shank 12 has a cylindrical form in this embodiment, but it may have any other form as may be required by the service. Portion 15 comprises a hexagonal arrangement of flat surfaces for engaging a tool, for example a ratchet wrench.

Biasing members or disc springs 30, 31 are disposed between flange 11 and flange 42. Flange 11 extends substantially normal to shank 12. Disc springs 30, 31 are shown in a parallel configuration, but may also be used in a series configuration as well.

Jacket 20 comprises flanges 21 and 22. Flange 21 engages flange 11. Flange 22 engages flange 42. Flanges 21, 22 are rolled or crimped around each of the cooperating flanges 11, 42 respectively, thereby permanently holding the assembly together while at the same time keeping debris from entering the assembly. Debris contamination of nut 10, shank 12, conical seat 40, and disc springs 30, 31 can seriously degrade the torque holding capability and long term operation of the conical nut by creating a situation where the installation torque might slowly “bleed off”. The jacket prevents this from occurring by sealing the conical nut and thereby preventing debris from entering and contaminating the various conical nut components, in particular the disc springs 30, 31.

Jacket 20 is installed so as to put disc springs 30, 31 under a slight compression to render the assembly somewhat rigid. However, conical seat 40 is allowed to swivel freely during installation to minimize torque loss due to friction between the nut 10 and the disc springs 30, 31, and conical seat 40.

An internal bore 13 of nut 10 is threaded to engage a threaded bolt or stud 400 (see FIG. 6). The bolt or stud is most likely a component of a vehicle wheel hub, such as on a trailer axle. However, it should be noted that the inventive conical nut may be used in any application requiring a nut capable of preventing torque bleed below a predetermined minimum clamp force.

Surface 41 of conical seat 40 comprises a cone angle α thereby giving a taper to properly engage a wheel flange hole 201. Wheel flange hole 201 has a nut seat angle β which cooperates with surface 41 (see FIG. 6). The taper is such that conical seat 40 self aligns with a wheel flange hole 201 during use. Namely, the cone angle α substantially matches the nut seat angle β to minimize clamp loss due to friction during installation, see FIG. 3.

FIG. 1 depicts the disc springs stacked in parallel. Other arrangements include stacking in series where the springs are arranged back to back, as well as in parallel-series where pairs of springs in parallel are stacked in series, back to back.

FIG. 2 is a cross-sectional view of the disc spring. Disc spring 30 comprises a bore 32. Bore 32 allows disc spring 30 to concentrically engage shank 12. Disc spring 30 and 31 preferably comprise Belleville springs.

Belleville springs demonstrate known and predictable characteristics in compression. The spring characteristics are a function of the height h, thickness t, radius ro, radius r₁ and load L. Radius r₁ is slightly larger than the radius of shank 12 which allows a sliding fit between the disc springs and the shank.

Proper selection of the ratio h/t allows a predetermined load, or in this case a stud preload, to be substantially constant over a significant deflection range. This means the nut 10 can unscrew a substantial distance, thereby causing disc springs 30, 31 to deflect, and yet the disc springs 30, 31 will maintain a constant minimum preload on the stud 400, see FIG. 6. A higher load for a given deflection can be realized by stacking the springs in parallel as shown in FIG. 1.

Preload L is the desired design preload in the stud or bolt. The desired stud preload L is achieved by the installation torque on the nut 10. Each of these concepts is well known in the mechanical arts. Selection of the proper stud preload assures proper service for the conical nut 100 and ultimate retention of the wheel on a hub.

Use of the disc springs 30, 31 compensates for the effects of nut 10 being loosened during operation. The disc springs maintain the proper preload on the stud or bolt even if the nut turns or partially unscrews from the stud or bolt, or if the components yield or are otherwise misaligned through use. For example, unintended partial rotation of nut 10 may occur during operation if a flat of the nut is struck by a piece of debris. Repeated strikes might otherwise loosen the nut, but the disc springs enhance the ability of the nut to maintain proper preload on the stud or bolt. Mechanical yielding by the components or paint failure may also cause torque to bleed off as well, but such torque bleed is prevented by use of the disc springs 30, 31.

The following table is offered to illustrate a range of approximate torque values that are based upon the diameter of the stud or bolt. These figures are only offered by way of example and are not intended to limit the application of the inventive conical nut.

| Stud Diameter | Torque Range |
|---|---|
| ½″ | ˜60 to 120 ft/lbs |
| 9/16″ | ˜90 to 170 ft/lbs |
| ⅝″ | ˜190 to 325 ft/lbs |

In an example system, a set of conical nuts are each torqued down on a ½″ stud (400) to mount a wheel (200) on a trailer hub (300). The number of conical nuts utilized per wheel can include 4, 5, 6, or 8. Once each conical nut 100 is fully torqued disc springs 30, 31 are fully compressed. The torque in this example situation is approximately 120 ft/lbs. The clamp force between each conical nut and the hub in this example is approximately 15,000 pounds. In the case where the torque might then bleed off on one or more conical nut, for example by plastic deformation of the wheel or extrusion of paint on the wheel, the inventive conical nut will continue to provide a clamp force of not less than approximately 8,000 pounds by action of the disc springs 30, 31. Namely, the torque could bleed off until a minimum torque sustainable by the conical nut is reached, i.e., in this example a torque consistent with an approximate 8,000 pound clamp force. Due to the characteristics of the disc springs, the minimum clamp force (F₁) of approximately 8,000 pounds then remains substantially constant over a range of further axial movement (loosening) unless or until the nut is significantly loosened beyond the range of movement, or until it is removed. In this particular example, a minimum safe clamp force (F₂) is approximately 6,000 pounds, so the benefit of the conical nut holding a minimum clamp force (8,000 pounds) greater than the minimum safe clamp force (6,000 pounds) is apparent, i.e., F₁>F₂. This desirable characteristic of the conical nut has the effect of extending the time envelope in which a user might have the opportunity to detect a reduction or loss of torque on the nut, for example during a routine maintenance check, thereby allowing the conical nut to be re-tightened prior to a failure of the wheel/hub assembly. This description is also illustrative of the other stud diameters noted in the table.

FIG. 3 is a cross-sectional view of the conical seat. Conical seat 40 is tapered comprising a cone angle α. Cone angle α may be in the range of approximately 30° to approximately 45°. The preferred cone angle is approximately 30°. Bore 43 allows conical seat 40 to concentrically engage shank 12. Bore 43 has a slightly larger diameter than shank 12 to allow a sliding fit and lateral shift between them.

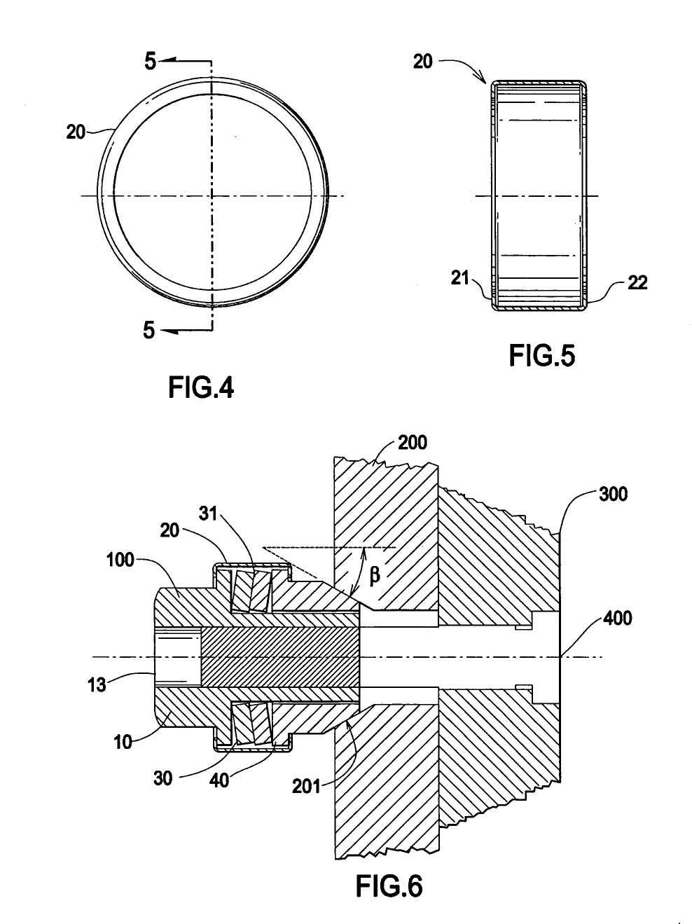

FIG. 4 is a plan view of the jacket. Containing member or jacket 20 is circular and has a diameter that is slightly greater than the diameter of flange 11 and flange 42. Jacket 20 also has a diameter that is slightly greater than the diameter of disc springs 30, 31 in the fully compressed state. This prevents disc springs 30, 31 from engaging or distorting jacket 20 when the nut is installed on a bolt or stud. Jacket 20 contains disc springs 30, 31 between the nit 10 and the conical seat 40. Although jacket 20 is shown without apertures, material may be removed from the sides of jacket 20 in order to reduce the amount or weight of material used in its construction.

FIG. 5 is section 5-5 in FIG. 4. Flanges 21, 22 are rolled or crimped. Flanges 21, 22 are of a size sufficient to retain jacket 20 on flanges 11 and 42. Jacket 20 is functional during installation of the conical nut as well as during removal of the conical nut. As the conical nut 100 is installed to a final torque value, jacket 20 simply concentrically telescopes on the outside of conical seat 40. As conical nut 100 is removed jacket 20 reengages both flange 11 and flange 42 to keep the assembly together, ready for its next use or reinstallation. Put another way, jacket 20 is not a “stressed” member when the conical nut is installed and torqued, or during removal.

FIG. 6 is a cross-sectional view of the conical nut installed on a wheel hub. Conical nut 100 is threaded onto threaded stud 400. Stud 400 is typically press fit into a hub 300. Hub 300 is typically attached to a vehicle or trailer axle (not shown). Wheel 200 is fastened to hub 300 by one or more conical nuts 100. In most cases five conical nuts are used to attach a wheel to a hub. Wheel 200 comprises a wheel hole 201 which receives the conical nut assembly 100. Stud 400 projects through wheel hole 210.

Although a form of the invention has been described herein, it will be obvious to those skilled in the art that variations may be made in the construction and relation of parts without departing from the spirit and scope of the invention described herein.

We claim:

1. A conical nut comprising:
a body (10) having a cylindrical portion (12), a first threaded bore (13) and a flange (11) extending substantially normal to the cylindrical portion;
a biasing member comprising at least two disc springs (30, 31), each disc spring having a bore engagable with the cylindrical portion;
a seat (40) having a tapered surface and having a second bore (43) engagable with the cylindrical portion;
the biasing member disposed between the flange and the seat; and
a containing member (20) engaged to the flange and the seat whereby the biasing member is contained between the flange and the seat.

2. The conical nut as in claim 1, wherein the tapered surface further comprises an angle in the range of approximately 30° to approximately 45°.

3. The conical nut as in claim 1, wherein the body comprises a portion for engaging a tool.

4. The conical nut as in claim 1, wherein:
the seat comprises a second flange; and
the containing member is engaged with the flange and second flange.

5. The conical nut as in claim 1, wherein the two disc springs are arranged in parallel.

6. A wheel system comprising:
a hub having a stud;
a body threadably engagable with the stud;
a conical seat engagable with a wheel portion, the wheel portion clamped between the conical seat and the hub by engagement of the body with the stud;
a biasing member comprising at least two disc springs arranged in parallel, the biasing member disposed between the body and the conical seat;
a jacket engaged between the body and the conical seat, the jacket disposed about the biasing member to prevent debris from entering between the body and the conical seat; and
the biasing member maintaining a predetermined minimum clamp force between the conical seat and the wheel.

7. The wheel system as in claim 6, wherein the conical seat further comprises a tapered surface comprising an angle in the range of approximately 30° to approximately 45°.

8. A conical nut comprising:
a body having a cylindrical portion and a threaded bore;
a biasing member comprising a disc spring, the disc spring having a bore engagable with the cylindrical portion;
a conical seat having a bore engagable with the cylindrical portion;
the biasing member disposed between the body and the conical seat; and
a containing member engaged with the body and the conical seat to substantially seal the biasing member from debris.

9. The conical nut as in claim 8 further comprising a second disc spring arranged in series with the disc spring.

10. The conical nut as in claim 8 further comprising a second disc spring arranged in parallel with the disc spring.

11. The conical nut as in claim 8, wherein the conical seat further comprises a tapered surface comprising an angle in the range of approximately 30° to approximately 45°.
